(19) United States
(12) Patent Application Publication
(10) Pub. No.: US 2006/0226256 A1
(43) Pub. Date: Oct. 12, 2006

(54) Oscillating waterfall shower

(76) Inventors: Jeffrey A. DeBoer, Ann Arbor, MI (US); Aaron M. Hughes, San Francisco, CA (US)

Correspondence Address: CARLSON, GASKEY & OLDS, P.C., 400 WEST MAPLE ROAD, SUITE 350, BIRMINGHAM, MI, 48009, US

(21) Appl. No.: 11/083,603

(22) Filed: Mar. 18, 2005

(51) Int. Cl. B05B 3/00

(52) U.S. Cl. 239/225.1; 239/282; 239/242

(57) ABSTRACT

A showerhead assembly includes a showerhead that is generally cylindrical in shape and mounted to a shower wall. The showerhead is mounted to oscillate and spray water to provide a standing immersion sensation.

### BACKGROUND OF THE INVENTION

The present invention relates to a shower, and more particularly to a showerhead assembly that generates sheets of water and oscillates relative a shower wall to provide a waterfall effect.

Oversized luxury showers and accessories are becoming increasing desirable in new construction and bathroom renovations. Such showers typically include one or more a multi-function showerheads that have a plurality of spray modes, including various standard sprays and pulsed sprays. Multi-function showerheads may also have flow control valves to allow the user to adjust the flow pressure to a desired level. Other conventional showerheads provide simulated rainfall or waterfall experiences.

Although somewhat effective in providing such simulated experiences, conventional rainfall and waterfall showerheads may be lacking in the simulated rainfall or waterfall effect. Such effects may also be constrained relatively close to a shower wall which minimizes the bather's experience.

Accordingly, it is desirable to provide a showerhead assembly which provides a significantly satisfactory simulation of being within a rainfall or waterfall.

### SUMMARY OF THE INVENTION

A showerhead assembly according to the present invention includes a showerhead that is generally cylindrical in shape and mounted to a shower wall. The showerhead is mounted to oscillate and spray water to provide a standing immersion sensation.

The present invention therefore provide a showerhead assembly which provides a significantly satisfactory simulation of being within a rainfall or waterfall.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view an exemplary shower surround and showerhead assembly;

FIG. 2 is an expanded view of a showerhead assembly designed according to the present invention;

FIG. 3 is a schematic side view of a showerhead assembly illustrating movement thereof; and

FIG. 4 is an expanded view of another showerhead assembly.

### DETAILED DESCRIPTION OF THE PREFERRED EMBODIMENT

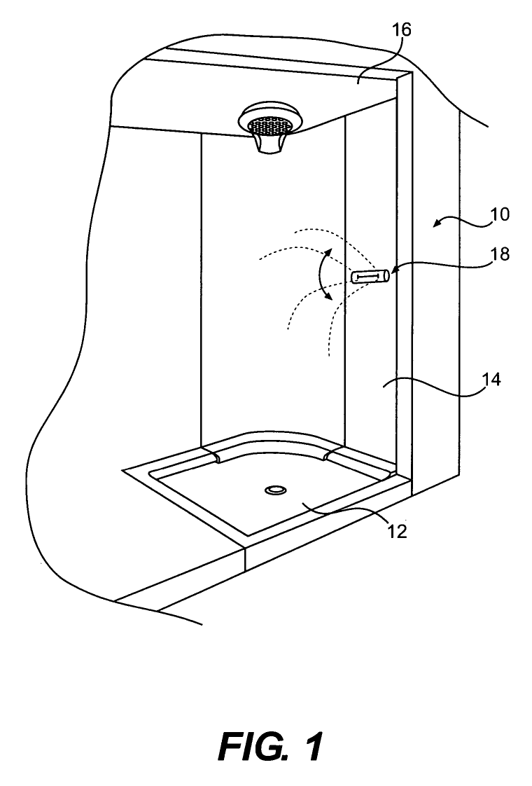

FIG. 1 illustrates a general perspective view of a shower surround 10. The surround 10 generally includes a base 12, one or more walls 14 and a ceiling 16. It should be understood that the term “base” is not limited to just shower bases but that relatively deeper tubs and the like will also benefit from the present invention. It should be understood that although a particular component arrangement is disclosed in the illustrated embodiment, other arrangements, e.g. molded surround or tiled construction will benefit from the instant invention.

The shower surround 10 includes a showerhead assembly 18 mounted to the wall 14. The showerhead assembly 18 preferably oscillates while dispensing water in sheets to provides a fan-like waterfall effect to the bather.

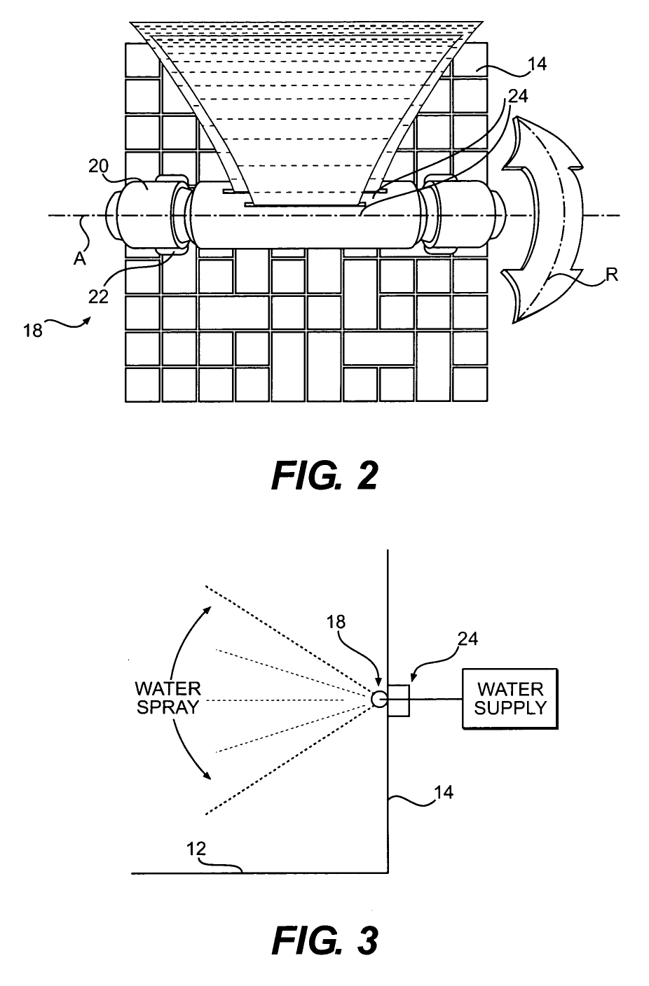

Referring to FIG. 2, the showerhead assembly 18 generally includes a showerhead 20 mounted to a support 22. The support 22 is mounted to a shower wall 14 such that the showerhead 20 is directed toward the interior of the shower 10 (FIG. 1). The support 22 preferably extends from the shower wall 14 and defines an axis of rotation A about which the showerhead 20 oscillates (as schematically illustrated by arrow R).

The showerhead 20 is generally cylindrical in shape and includes longitudinal slots 24 generally parallel to the axis of rotation R. That is, the showerhead 20 is mounted to the support 22 such that as the showerhead oscillates, the water dispensed therefrom defines a fan of water relative the shower wall 14 (FIG. 3). It should be understood that although a sheeting waterfall shower is preferred, other shower effects will also be usable with the present invention.

The showerhead 20 is driven by a drive system 24. The drive system 24 selectively articulates the showerhead 20 about the axis of rotation A. The drive system 24 may be a mechanical system, which is powered by water pressure to oscillate the showerhead 20 in a manner similar to an outdoor sprinkler. By utilizing water pressure the showerhead 20 may be both supplied and driven by water which thereby reduces installation complexity (FIG. 3). It should be understood that various drive systems will be usable with the present invention.

The showerhead 20 preferably sprays the water in sheets. As the showerhead 20 oscillates, the sheets of water define an arc with a predefined angle (FIG. 3).

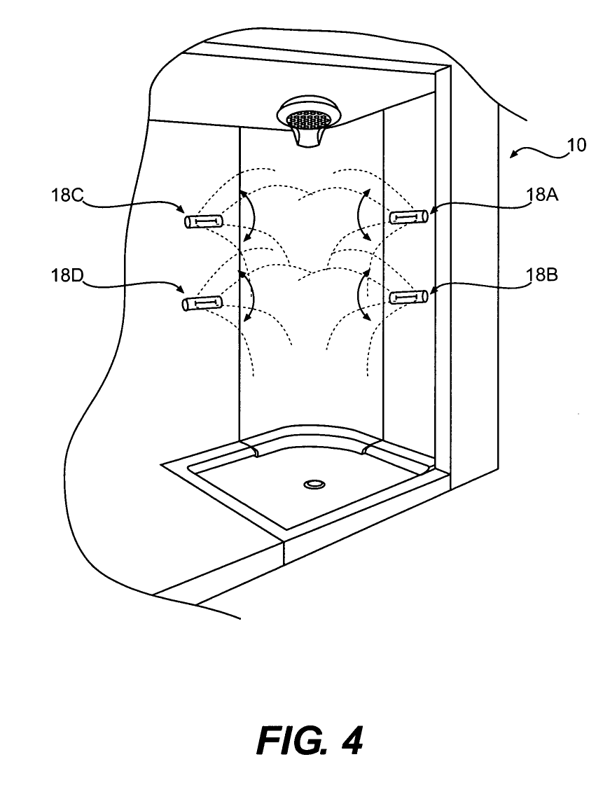

Referring to FIG. 4, a multitude of showerhead assemblies 18A-18D may be mounted in parallel along the shower wall to provide a standing immersion sensation within a shower 10. The multitude of showerhead assemblies 18A-18D may pivot together or individually in various patterns to provide different effects.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A showerhead assembly comprising:
a support which defines an axis of rotation; and
a showerhead mounted to said transverse for oscillatory movement about said axis of rotation.

2. The showerhead assembly as recited in claim 1, wherein said showerhead is generally cylindrical.

3. The showerhead assembly as recited in claim 1, wherein said showerhead includes rectilinear spray ports.

4. The showerhead assembly as recited in claim 3, wherein said showerhead dispenses water as a sheet.

5. A shower comprising:
a shower wall;
a support which defines an axis of rotation, said support mounted to said shower wall; and
a showerhead mounted to said support for oscillatory movement about said axis of rotation.

6. The shower as recited in claim 5, wherein said showerhead is generally cylindrical.

7. The shower as recited in claim 5, wherein said axis of rotation is generally parallel to a shower base.

8. The shower as recited in claim 7, wherein said showerhead dispenses water in a fan pattern.

9. A method of showering water comprising the steps of:
(1) locating a support on a shower wall, the support defining an axis of rotation;
(2) rotationally mounting the showerhead on the support for rotation about said axis of rotation; and
(2) oscillating the showerhead about the axis of rotation and showering water from the showerhead.

10. A method as recited in claim 9, further comprising the step of:
articulating the showerhead within a predefined angle.

11. A method as recited in claim 10, further comprising the step of:
showering water from the showerhead as a sheet of water.
